(19) United States
(12) Patent Application Publication
(10) Pub. No.: US 2021/0341294 A1
(43) Pub. Date: Nov. 4, 2021

(54) IN-TRANSIT DRIVING RECOMMENDATIONS THROUGH ARTIFICIAL INTELLIGENCE

(71) Applicant: International Business Machines Corporation, Armonk, NY (US)

(72) Inventors: SUDHAKAR T. SESHAGIRI, Bangalore (IN); Shwetha Gopalakrishna, Banagalore (IN); PRASANNA ALUR MATHADA, Bangalore (IN); Shruthi Ravindra, Bangalore (IN)

(21) Appl. No.: 16/862,764

(22) Filed: Apr. 30, 2020

(51) Int. Cl. G01C 21/34; G01C 21/36; G06K 9/32; G06F 16/907; G06N 20/00

(52) U.S. Cl. CPC G01C 21/343; G01C 21/3476; G01C 21/3484; G06Q 50/01; G06K 9/3233; G06F 16/907; G06N 20/00; G01C 21/3605

(57) ABSTRACT

An approach is provided that trains an artificial intelligence system to understand user preferences with least some of these preferences being learned from social media data pertaining to the user. The approach identifies points of interest between a starting location and a planned destination. The identification is performed while the user is traveling by automobile to the planned destination. The planned destination is included in an itinerary. The approach calculates an affinity score between the points of interest and the user preferences and recommends a set of points of interest based on the calculated affinity scores. A selection is received from the user of one of the points of interest from the recommended set. The itinerary is updated to include traveling to the selected point of interest and the user is provided with a set of driving instructions according to the updated itinerary.

### BACKGROUND

Long automobile trips can be tedious and boring. Bored drivers can suffer from paying less attention to the road and might even fall asleep at the wheel causing dangerous, if not deadly, consequences. In addition, spending too long sitting in an automobile at one time can cause health issues, such as back pain and, in some cases, more serious issues such as deep vein thrombosis (DVT) that can cause dangerous blood clots. Many drivers try to plan extra time for increased flexibility and to allow time for “pit stops” where the driver and other occupants take a break from driving. A challenge, however, is that users, such as drivers and occupants, might not know of a point of interest along the route that would be interesting and fun for the user's to visit along the way. Even when a point of interest is known, without considerable preplanning the users often do not know how much time would need to be allotted to visit the point of interest and how such a visit would affect the time to reach the ultimate destination.

### SUMMARY

An approach is provided that trains an artificial intelligence system to understand user preferences with least some of these preferences being learned from social media data pertaining to the user. The approach identifies points of interest between a starting location and a planned destination. The identification is performed while the user is traveling by automobile to the planned destination. The planned destination is included in an itinerary. The approach calculates an affinity score between the points of interest and the user preferences and recommends a set of points of interest based on the calculated affinity scores. A selection is received from the user of one of the points of interest from the recommended set. The itinerary is updated to include traveling to the selected point of interest and the user is provided with a set of driving instructions according to the updated itinerary.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram that shows components used to implement an artificial intelligence (AI) system that provides in-transit driving recommendations;

FIG. 4 is a depiction of a flowchart showing the logic used to ingest and train an artificial intelligence system regarding points of interest;

FIG. 5 is a depiction of a flowchart showing the logic used to ingest and train an artificial intelligence system regarding user-based data;

FIG. 6 is a depiction of a flowchart showing the logic used to implement in-transit artificial intelligence support for points of interest;

FIG. 7 is a depiction of a flowchart showing the logic used to allow user selection of recommended points of interests; and

FIG. 8 is a depiction of a flowchart showing the logic used to calculate an affinity score between points of interests and the user's interests.

### DETAILED DESCRIPTION

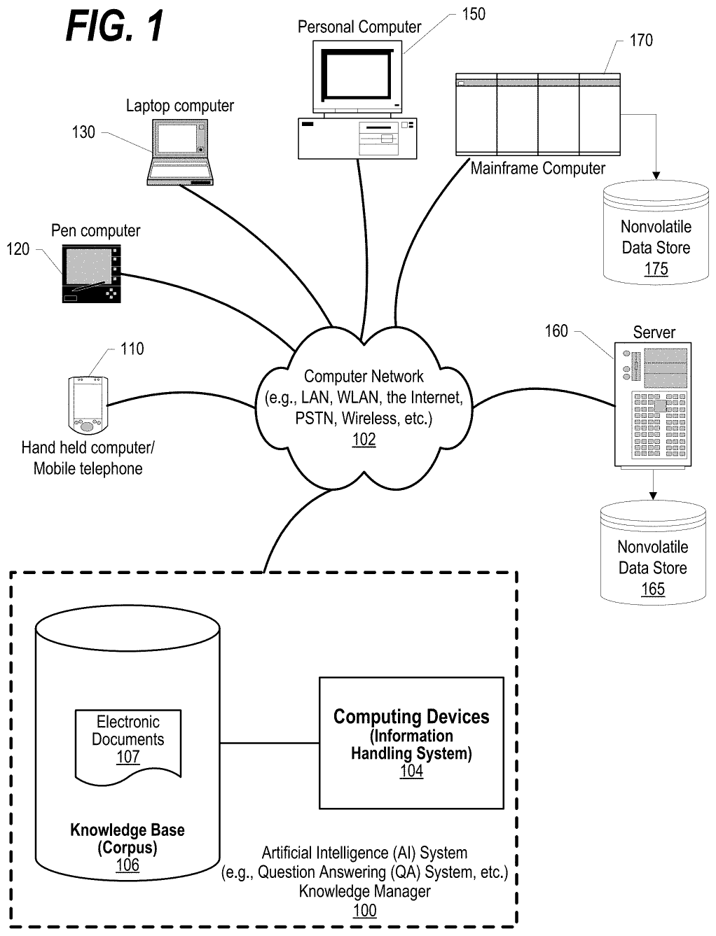

FIGS. 1-8 describe an approach that utilizes an artificial intelligence (AI) system to suggest points of interest that may be of interest to users that are driving to a destination, such as a long distance drive. The approach collects the data from various sources, such as social media sources and other online accessible sources, and uses machine learning to understand what points of interest are within close proximity of the route taken to a destination. The AI system also learns what is of interest to the users (e.g., driver, passengers, etc. in the vehicle) to identify points of interest that may be of particular interest to one or more of the users. Analytics regarding current media inputs and current affairs are also considered along with anthropometric and behavior data of the users. The approach can analyze data from user devices (e.g., smartphones, etc.), apps on such devices, and frequency of use of such apps. In addition, analytics using data regarding popular destinations and information from the user's past trips allow for recommendations to have the users visit points of interest that match with the users' personal interests.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of artificial intelligence (AI) system 100, such as a question/answer creation (QA) system, in a computer network 102. AI system 100 may include a knowledge manager computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable question/answer (QA) generation functionality for one or more content users. Other embodiments of AI system 100 may be used with components, systems, sub-systems, and/or devices other than those that are depicted herein.

AI system 100 uses AI model 105 that is a result of training the AI system. The model is a mathematical model that generates predictions by finding patterns in the data stored in corpus 106. In artificial intelligence, AI models 105 are based on the reasoning that works on methods in the AI system. AI models 105 observe data in corpus 106 to derive conclusions and make predictions about such data.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and may input questions to AI system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. AI system 100 may interpret the question and provide a response to the content user containing one or more answers to the question. In some embodiments, AI system 100 may provide a response to users in a ranked list of answers.

In some illustrative embodiments, AI system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

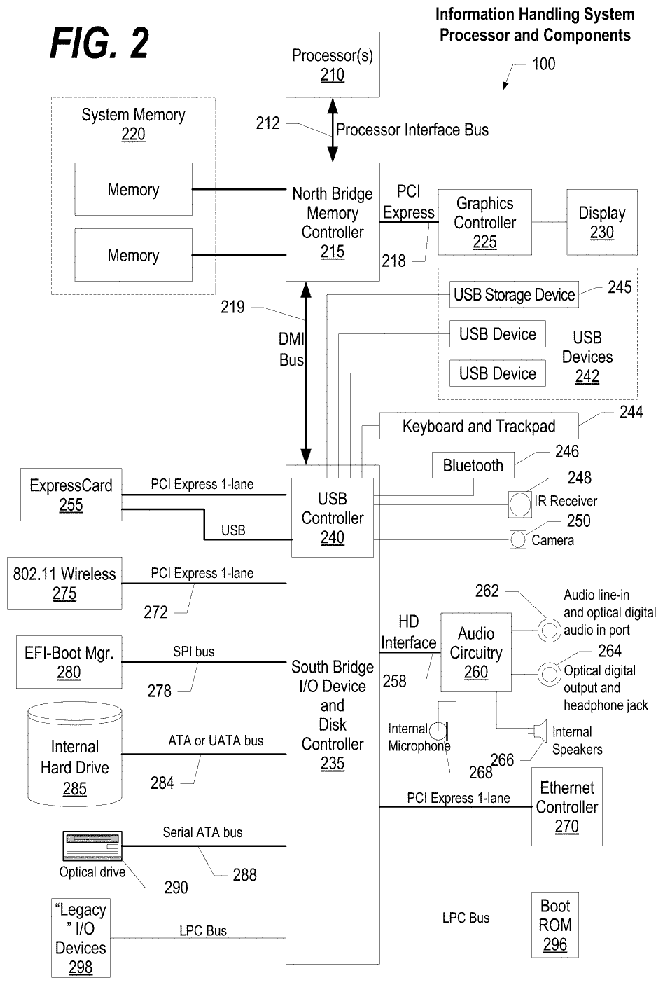

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

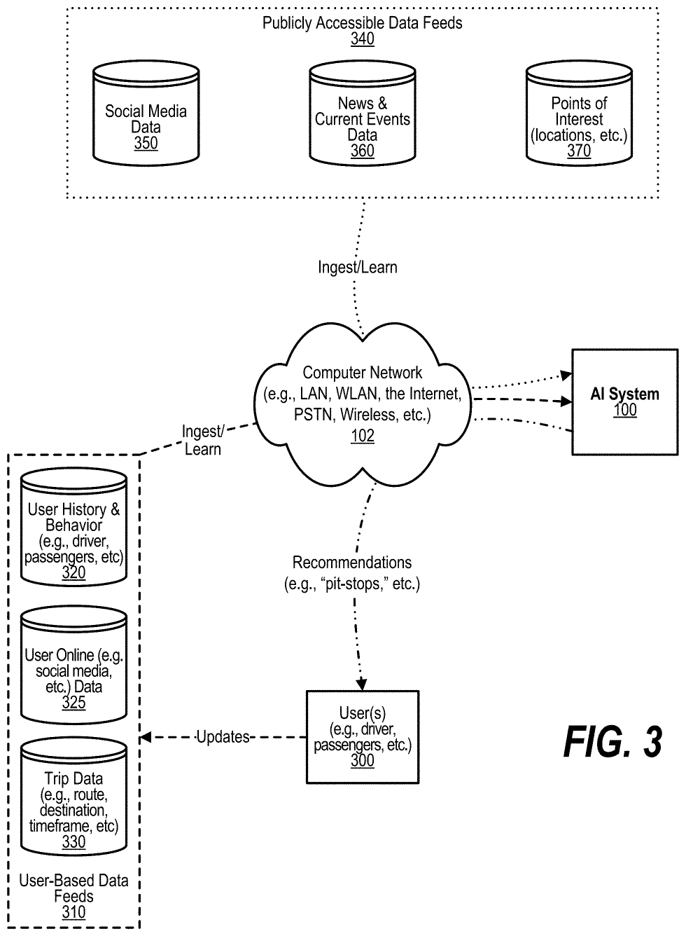

FIG. 3 is a component diagram that shows components used to implement an artificial intelligence (AI) system that provides in-transit driving recommendations. Users 300, such as a driver of an automobile and passengers therein, utilize devices such as mobile computing devices (e.g., smartphones, etc.) and perhaps a computer system built-in to the automobile console as well as any other systems regularly used by such users to provide updated data to user-based feeds 310. User-based feeds 310 are data sources that include data pertaining to one or more of the users. Examples of user-based feeds include user history and behavior data store 320 that includes a user's history and behavior both pertaining to history and behavior while in an automobile (e.g., destinations, stops, side trips, etc.) as well as history and behavior data gathered while the user is not in an automobile (e.g., at home, at work, etc.). Another user-based feed example is user online data stores 325, such as the user's presence in various social media web sites, online blogs, etc. Such online data stores may indicate a user's likes and dislikes regarding various activities as well as the strength of such activities based on the frequency at which a user engages in a particular activity (e.g., how often the user visited museums, etc.). Another user-based feed example is trip data store 330 that includes data about a current trip as well as data about other trips taken by the user. This trip data includes the route taken (e.g., back roads, highways, toll-roads, etc.), destinations including pit-stops or side trips taken during a trip, and a timeframe indicating the amount of time such trips took. In the case of a current trip, the timeframe can also be the time at which the user desires to reach a final destination so that the system can determine an amount of time the user may have to take enjoyable side trips while on the way to the ultimate destination.

AI system 100 learns and ingests the data from user-based data feeds 310 in order to predict points of interest that have a high level of affinity with the user's preferences as ascertained by learning the user's preferences, using machine learning, based on the data in the user-based data feeds. In addition, AI system 100 ingests, or learns, about points of interest from various publicly accessible data feeds 340. These publicly accessible data feeds include social media data stores 350, such as what friends and others comment about various points of interest (e.g., how enjoyable a museum was to tour, the amount of time recommended to have an enjoyable tour of the museum, etc.). Publicly accessible data feeds also include news and current event data store 360 that might indicate, for example, points of interest that are taking place at a particular time or date, such as a concert or other planned event. News and current event data store 360 might also indicate new points of interest that have recently opened (e.g., a new museum, etc.) or an event that is taking place at a long-established venue (e.g., a traveling exhibit that will be at a museum for a limited time, etc.). Publicly accessible data feeds 340 also includes data regarding points of interest from data store 370, such as names and geographic locations of such points of interest (e.g., name and geographic location of museums, etc.).

AI system 100 takes the ingested/learned publicly accessible data from publicly accessible data feeds 340 and matches the points of interest with the user's preferences that were ascertained by ingesting and learning the user's history, experiences, and behavior from user-based data feeds 310. As used herein, “points of interest” can be places that a person can physically visit, such as a museum, park, etc., an event, such as a concert, performance, production, etc., or any other activity that a person can personally visit while traveling to an ultimate destination.

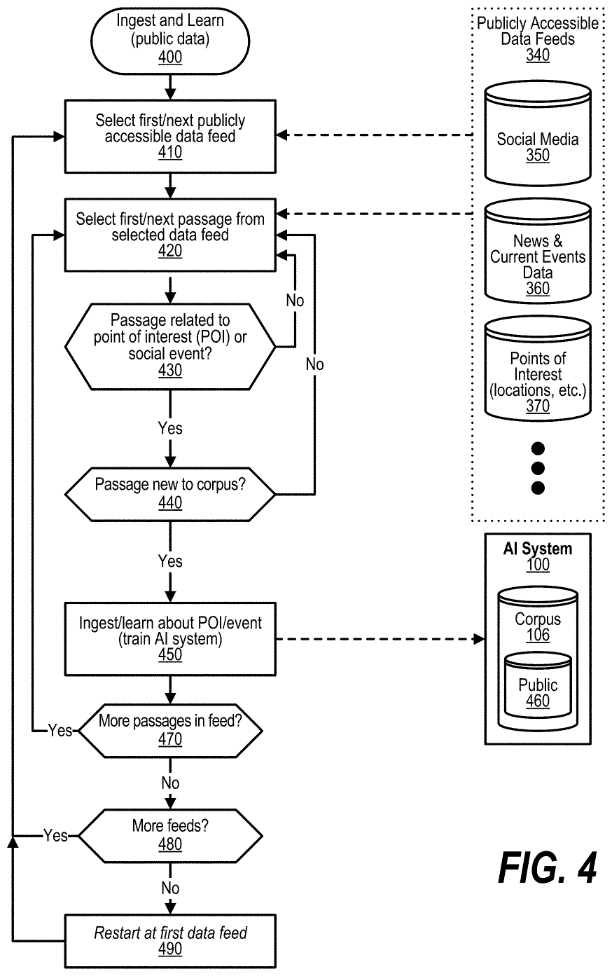

FIG. 4 is a depiction of a flowchart showing the logic used to ingest and train an artificial intelligence system regarding points of interest. FIG. 4 processing commences at 400 and shows the steps taken by a process that ingests and performs machine learning for an artificial intelligence (AI) system of public data regarding points of interest. At step 410, the process selects the first publicly accessible data feed from publicly accessible data feeds 340 (e.g., social media data stores 350, news and current events data stores 360, points of interest data stores 370, etc.).

At step 420, the process selects the first passage from the selected data feed. The process determines as to whether the selected passage is related to a point of interest (POI) such as a venue or social event (decision 430). If the selected passage is related to a point of interest, then decision 430 branches to the ‘yes’ branch for further processing. On the other hand, if the selected passage is not related to a point of interest, then decision 430 branches to the ‘no’ branch which loops back to select and process the next passage from the selected data feed.

When a passage is related to a point of interest, the process next determines whether the selected passage is new to the AI corpus or has already been processed (ingested/learned) by the AI (decision 440). If the passage is new to the AI corpus, then decision 440 branches to the ‘yes’ branch whereupon, at step 450, the process ingests (learns) about a point of interest by training the AI system about the POI referenced in the passage. This learning process updates public AI data 460 included in corpus 106 that is maintained and utilized by AI system 100. On the other hand, if the passage is not new to the AI corpus, then decision 440 branches to the ‘no’ branch which loops back to select and process the next passage from the selected data feed.

The process determines whether there are more passages in the selected data feed to process (decision 470). If there are more passages in the data feed, then decision 470 branches to the ‘yes’ branch which loops back to step 420 to select and process the next passage as discussed above. This looping continues until all passages in the selected data feed have been processed, at which point decision 470 branches to the ‘no’ branch exiting the loop.

When all passages of the selected data feed have been processed, the process next determines whether there are more publicly accessible data feeds to select and process (decision 480). If there are more publicly accessible data feeds yet to process, then decision 480 branches to the ‘yes’ branch which loops back to step 410 to select and process the next publicly accessible data feed. This looping continues until all data feeds have been processed, at which point decision 480 branches to the ‘no’ branch exiting the loop. Being a continuous process, at step 490, the process restarts at first data feed by selecting and processing all of the publicly accessible data feeds and ingesting/learning any new data that has been added to such data feeds since the last time the process was performed.

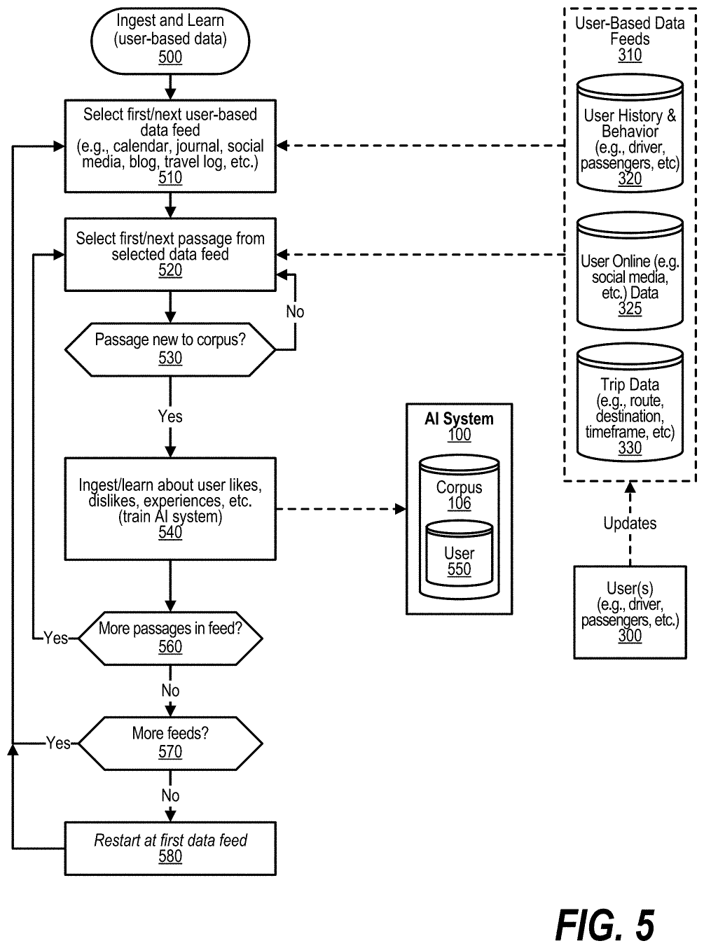

FIG. 5 is a depiction of a flowchart showing the logic used to ingest and train an artificial intelligence system regarding user-based data. FIG. 5 processing commences at 500 and shows the steps taken by a artificial intelligence process that ingests data and uses machine learning to understand and predict a user's preferences with regard to points of interest that the user may encounter while traveling. At step 510, the process selects the first user-based data feed (e.g., calendar, journal, social media, blog, travel log, etc.) for a variety of data feeds shown in user-based data feeds 310. At step 520, the process selects the first passage from the selected data feed.

The process determines as to whether the selected passage is new to the artificial intelligence corpus (decision 530). If the selected passage is new, then decision 530 branches to the ‘yes’ branch for further processing. On the other hand, if the selected passage is not new to the corpus, then decision 530 branches to the ‘no’ branch which loops back to select the next passage from the selected data feed. At step 540, the process ingests (machine learning) about the user's likes, dislikes, experiences, and the like and thereby trains the AI system accordingly.

The process determines whether there are more passages in the selected data feed to process (decision 560). If there are more passages in the selected data feed to process, then decision 560 branches to the ‘yes’ branch which loops back to step 520 to select and process the next passage from the selected data feed. This looping continues until all passages from the selected data feed have been processed, at which point decision 560 branches to the ‘no’ branch exiting the loop. The process determines whether there are more user-based data feeds to select and process (decision 570). If there are more user-based data feeds to select and process, then decision 570 branches to the ‘yes’ branch which loops back to step 510 to select and process the next data feed from data feeds 310.

This looping continues until all of the data feeds have been processed, at which point decision 570 branches to the ‘no’ branch exiting the loop. Being a continuous process, at step 580, the process restarts at first data feed to continue learning about the user's preferences by processing new data that arrives at any of the user-based data feeds. New data can arrive at data feeds 310 from updates received from user(s) 300.

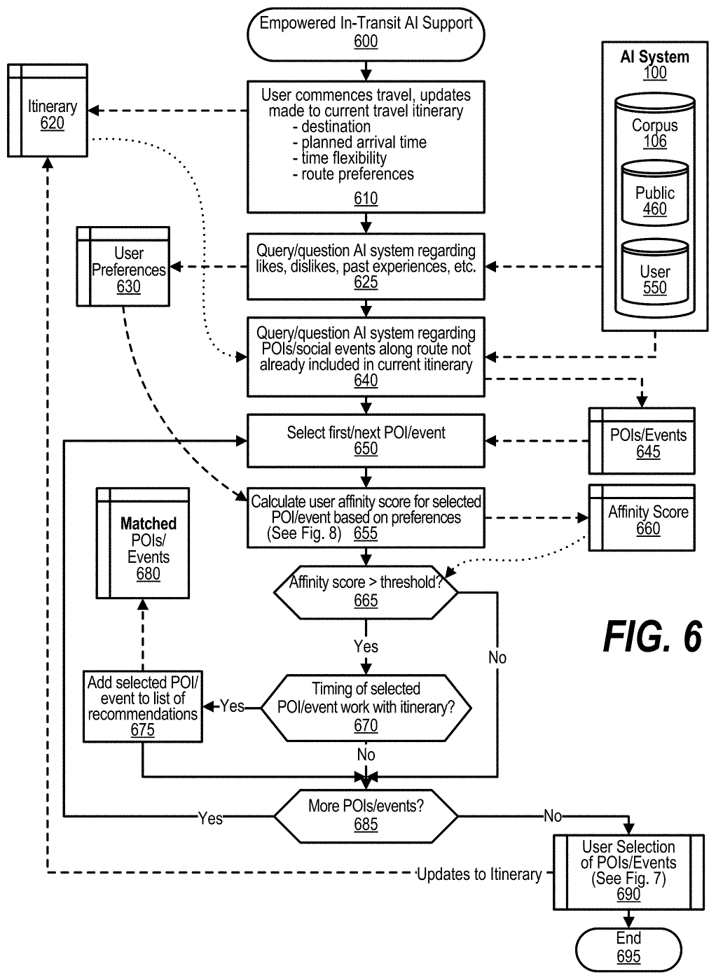

FIG. 6 is a depiction of a flowchart showing the logic used to implement in-transit artificial intelligence support for points of interest. FIG. 6 processing commences at 600 and shows the steps taken by a process that implements an empowered in-transit AI support to add points of interest to a user's itinerary based on the user's individual preferences. At step 610, the user commences traveling to an ultimate destination. Updates regarding the travel are made to the current travel itinerary that is stored in memory area 620. These updates include the user's planned (ultimate) destination, the planned arrival time, the user's time flexibility in arriving at the ultimate destination, as well as any of the user's route preferences (e.g., back roads, highways, etc.).

At step 625, the process queries (e.g., questions, etc.) AI system 100 regarding the user's preferences based on the user's likes, dislikes, past experiences, etc. that have been learned by the AI system using the process shown in FIG. 5. These user preferences are stored in memory area 630. At step 640, the process queries (e.g., questions, etc.) the AI system regarding the points of interest (e.g., venues, social events, etc.) that exist or that are going to be performed during the user's travels and that are geographically along the user's route and that have not already been included in user's current itinerary. These (possible) points of interest are stored in memory area 645.

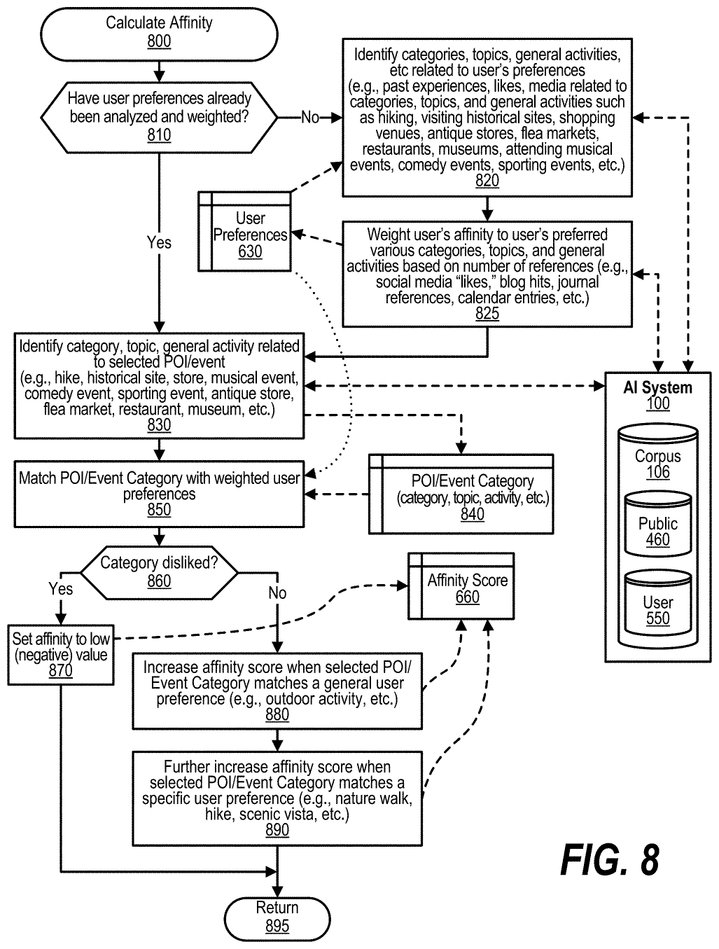

At step 650, the process selects the first point of interest from the set of points of interest stored in memory area 645. At step 655, the process calculates a user affinity score for the selected point of interest based on the user's preferences that were stored in memory area 630. FIG. 8 shows on embodiment of one approach to calculating the user affinity score. The process determines as to whether the user affinity score meets a particular threshold indicating a high enough level of affinity between the point of interest and the user's preferences (decision 665). If the calculated affinity score is high enough, then decision 665 branches to the ‘yes’ branch for further processing of the point of interest with steps 670 and 675. On the other hand, if the affinity score does not meet the threshold, then decision 665 branches to the ‘no’ branch bypassing steps 670 and 675. If the affinity score is high enough then the process determines if the timing of the selected point of interest will work with the user's itinerary (decision 670). For example, the user may be making a morning trip and the point of interest might be an outdoor concert along the way, but the concert is at night and the user is not expected to be near the concert venue when the concert takes place. On the other hand, the point of interest may be a fixed event, such as a park or museum, with visiting hours that are compared to the time at which the user is likely to be nearby. If the timing of the point of interest works with the user's current itinerary, then decision 670 branches to ‘yes’ branch whereupon, at step 675, the process adds the selected point of interest to the list of recommendations that are stored in memory area 680.

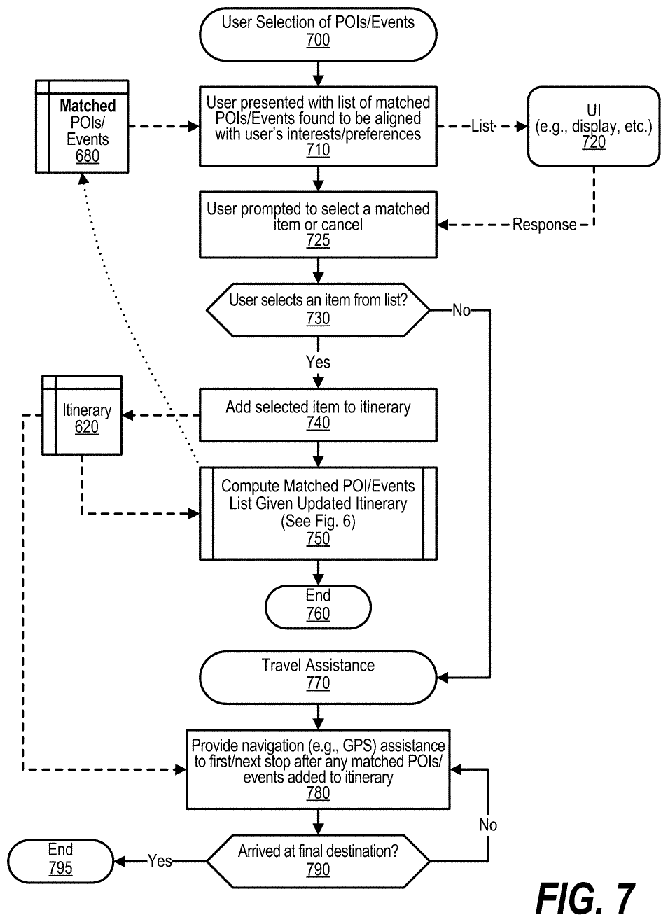

The process determines as to whether more points of interest to process (decision 685). If there are more points of interest to process, then decision 685 branches to the ‘yes’ branch which loops back to step 650 to select and process the next point of interest as described above. This looping continues until all of the points of interest from memory area 645 have been processed, at which point decision 685 branches to the ‘no’ branch exiting the loop. At predefined process 690, the process performs the User Selection of POIs/Events routine (see FIG. 7 and corresponding text for processing details). FIG. 6 processing thereafter ends at 695.

FIG. 7 is a depiction of a flowchart showing the logic used to allow user selection of recommended points of interests. FIG. 7 processing commences at 700 and shows the steps taken by a process that receives a user's selection of recommended points of interest. At step 710, the process presents the user with a list of matched points of interest that have been found to be aligned with user's preferences based by the calculated user affinity score. The matched points of interest are retrieved from memory area 680 and the list is displayed on user display screen 720.

At step 725, the process prompts the user to select a displayed point of interest to add to the user's itinerary or, if no points of interest are being added to the itinerary, then the user can cancel. The process determines as to whether the user selected an item (point of interest) to add to the user's itinerary from the displayed list (decision 730). If the user selected an item from the list, then decision 730 branches to the ‘yes’ branch whereupon, at step 740, the selected item is added to the itinerary stored in memory area 620 and at predefined process 750 the process re-computes the matched points of interest with the user's preferences using the updated itinerary (see FIG. 6 and corresponding text for details).

On the other hand, if the user cancels (does not add a point of interest from the list), then decision 730 branches to the ‘no’ branch whereupon processing branches to the travel assistance portion of the process that commences at 770. At step 780, the process provides navigation assistance (e.g., via on-board GPS, etc.) to the first stop listed in the itinerary after points of interest have been added to the itinerary by the user. The process determines as to whether the user has arrived at the final (last) destination listed in the itinerary (decision 790). When the user has arrived at the final destination, then decision 790 branches to the ‘yes’ branch and processing ends at 795. On the other hand, while the user has not arrived at the final destination, then decision 790 repeatedly branches to the ‘no’ branch to continue providing the user with driving and navigation assistance to the next destination (e.g., point of interest, final destination, etc.) that is listed in the itinerary.

FIG. 8 is a depiction of a flowchart showing the logic used to calculate an affinity score between points of interests and the user's interests. FIG. 8 processing commences at 800 and shows the steps taken by a process that calculates a user affinity score that is used to determine if a point of interest is of possible interest to the user. The process first determines whether the user's preferences have already been analyzed and weighted for use by the affinity scoring process (decision 810). If the user's preferences have already been analyzed and weighted for use by the affinity scoring process, then decision 810 branches to the ‘yes’ branch bypassing steps 820 and 825. On the other hand, if the user's preferences have not yet been analyzed and weighted for use by the affinity scoring process, then decision 810 branches to the ‘no’ branch to perform steps 820 and 825.

At step 820, the process identifies categories, topics, general activities, etc that are related to the user's preferences retrieved from memory area 630. For example, such categories, topics and the like might include the user's past experiences, “likes” on social media, media related to categories, topics, and general activities such as hiking, visiting historical sites, shopping venues visited by the user, antique stores, flea markets, restaurants, museums, attendance of musical events, comedy events, sporting events, by the user, and the like. At step 825, the process calculates an affinity weight based on the user's affinity to the user's preferred various categories, topics, and general activities based on number of references found for such categories, topics and the like. For example, the number of social media “likes,” blog hits, journal references, calendar entries, etc. can be collectively added and used as a weight that is applied to the corresponding preference. The result might be that the user highly enjoys outdoor hikes, somewhat enjoys live music, and really dislikes antique shops. The degree of likes and dislikes (weights) are used to identify points of interest that predicted to be of greater interest to the user.

At step 830, the process identifies the category, topic, general activity that is related to the selected point of interest selected by the calling routine. For example, the category, topic, general activity might be an outdoor hike, a historical site, a boutique store, a musical event, a comedy event, a sporting event, an antique store, a flea market, a restaurant, a museum, or the like. The point of interest category resulting from step 830 is stored in memory area 840. At step 850, the process matches the point of interest category that was found in step 830 with the weighted user preferences for the category.

The process determines as to whether the identified category is disliked by the user (decision 860). If the identified category is disliked by the user, then decision 860 branches to the ‘yes’ branch, whereupon, at step 870, the process sets the affinity of the selected point of interest to a negative (very low) value so that the point of interest will not be recommended and this low affinity score is stored in memory area 660. On the other hand, if the identified category is not disliked by the user, then decision 860 branches to the ‘no’ branch to perform steps 880 and 890.

At step 880, the process increases affinity score when the selected point of interest category matches a general user preference, such as the point of interest being an outdoor activity and the user generally enjoying outdoor activities, etc. In one embodiment, the amount of increase is based on the weight of the general user preference found by steps 820 and 825. At step 890, the process further increases the affinity score when the selected point of interest category matches a specific user preference (e.g., nature walk, hike, scenic vista, etc.). In one embodiment, the amount of increase is based on the weight of the specific user preference found by steps 820 and 825. FIG. 8 processing thereafter returns to the calling routine at 895.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
training an artificial intelligence system with a plurality of user preferences, wherein at least one set of data used to train the artificial intelligence system is a social media data pertaining to a user;
identifying one or more points of interest between a starting location and a planned destination, wherein the identifying is performed while traveling by automobile to the planned destination, and wherein the planned destination is included in an itinerary;
calculating an affinity score between the one or more points of interest and the user preferences;
recommending a set of one or more of the points of interest based on the calculated affinity scores;
receiving, from the user, a selection of a selected one of the points of interest from the recommended set;
updating the itinerary to include travel to the selected one of the points of interest; and
providing the user with a set of driving instructions according to the updated itinerary.

2. The method of claim 1 wherein the calculating further comprises:
ingesting a metadata pertaining to each of the plurality of points of interest into the artificial intelligence system;
weighting the user preferences based on a number of occurrences of data related to each of the user preferences used to train the artificial intelligence system; and
comparing the metadata pertaining to each of the plurality of points of interest to the weighted user preferences.

3. The method of claim 2 further comprising:
inhibiting inclusion of a selected one of the points of interest from the set of recommended points of interest based on a dislike of a selected one of the metadata corresponding to the selected one of the points of interest discovered by the training of the artificial intelligence system.

4. The method of claim 1 further comprising:
after receiving the selected point of interest:
updating an estimated time of arrival at the destination;
updating the recommended set of points of interest by removing the selected point of interest from the recommended set of points of interest; and
repeating the recommending of the set of points of interest after the updating.

5. The method of claim 1 wherein the training of the user preferences further comprises:
ingesting a set of prior user activities to the artificial intelligence system;
ingesting a set of social media posts to the artificial intelligence system; and
ingesting a set of travel history logs to the artificial intelligence system, wherein the history logs include a set of prior destinations visited by the user, and wherein the training of the artificial intelligence system with the plurality of user preferences further includes the ingested set of prior user activities, the ingested set of social media posts, and the ingested set of travel history logs.

6. The method of claim 5 further comprising:
learning of the user preferences based on a plurality of passages included in the sets of data ingested by the artificial intelligence system.

7. The method of claim 1 further comprising:
comparing each of the points of interest calculated affinity scores with a threshold, wherein the recommended set of points of interest are those points of interest with affinity scores that meet the threshold.

8. An information handling system comprising:
one or more processors;
a memory coupled to at least one of the processors; and
a set of computer program instructions stored in the memory and executed by at least one of the processors in order to perform actions comprising:
training an artificial intelligence system with a plurality of user preferences, wherein at least one set of data used to train the artificial intelligence system is a social media data pertaining to a user;
identifying one or more points of interest between a starting location and a planned destination, wherein the identifying is performed while traveling by automobile to the planned destination, and wherein the planned destination is included in an itinerary;
calculating an affinity score between the one or more points of interest and the user preferences;
recommending a set of one or more of the points of interest based on the calculated affinity scores;
receiving, from the user, a selection of a selected one of the points of interest from the recommended set;
updating the itinerary to include travel to the selected one of the points of interest; and
providing the user with a set of driving instructions according to the updated itinerary.

9. The information handling system of claim 8 wherein the calculating further comprises:
ingesting a metadata pertaining to each of the plurality of points of interest into the artificial intelligence system;
weighting the user preferences based on a number of occurrences of data related to each of the user preferences used to train the artificial intelligence system; and
comparing the metadata pertaining to each of the plurality of points of interest to the weighted user preferences.

10. The information handling system of claim 9 wherein the actions further comprise:
inhibiting inclusion of a selected one of the points of interest from the set of recommended points of interest based on a dislike of a selected one of the metadata corresponding to the selected one of the points of interest discovered by the training of the artificial intelligence system.

11. The information handling system of claim 8 wherein the actions further comprise:
after receiving the selected point of interest:
updating an estimated time of arrival at the destination;
updating the recommended set of points of interest by removing the selected point of interest from the recommended set of points of interest; and
repeating the recommending of the set of points of interest after the updating.

12. The information handling system of claim 8 wherein the training of the user preferences further comprises:
ingesting a set of prior user activities to the artificial intelligence system;
ingesting a set of social media posts to the artificial intelligence system; and
ingesting a set of travel history logs to the artificial intelligence system, wherein the history logs include a set of prior destinations visited by the user, and wherein the training of the artificial intelligence system with the plurality of user preferences further includes the ingested set of prior user activities, the ingested set of social media posts, and the ingested set of travel history logs.

13. The information handling system of claim 82 wherein the actions further comprise:
learning of the user preferences based on a plurality of passages included in the sets of data ingested by the artificial intelligence system.

14. The information handling system of claim 8 wherein the actions further comprise:
comparing each of the points of interest calculated affinity scores with a threshold, wherein the recommended set of points of interest are those points of interest with affinity scores that meet the threshold.

15. A computer program product stored in a computer readable storage medium, comprising computer program code that, when executed by an information handling system, performs actions comprising:
training an artificial intelligence system with a plurality of user preferences, wherein at least one set of data used to train the artificial intelligence system is a social media data pertaining to a user;
identifying one or more points of interest between a starting location and a planned destination, wherein the identifying is performed while traveling by automobile to the planned destination, and wherein the planned destination is included in an itinerary;
calculating an affinity score between the one or more points of interest and the user preferences;
recommending a set of one or more of the points of interest based on the calculated affinity scores;
receiving, from the user, a selection of a selected one of the points of interest from the recommended set;
updating the itinerary to include travel to the selected one of the points of interest; and
providing the user with a set of driving instructions according to the updated itinerary.

16. The computer program product of claim 15 wherein the calculating further comprises:
ingesting a metadata pertaining to each of the plurality of points of interest into the artificial intelligence system;
weighting the user preferences based on a number of occurrences of data related to each of the user preferences used to train the artificial intelligence system; and
comparing the metadata pertaining to each of the plurality of points of interest to the weighted user preferences.

17. The computer program product of claim 16 wherein the actions further comprise:
inhibiting inclusion of a selected one of the points of interest from the set of recommended points of interest based on a dislike of a selected one of the metadata corresponding to the selected one of the points of interest discovered by the training of the artificial intelligence system.

18. The computer program product of claim 15 wherein the actions further comprise:
after receiving the selected point of interest:
updating an estimated time of arrival at the destination;
updating the recommended set of points of interest by removing the selected point of interest from the recommended set of points of interest; and
repeating the recommending of the set of points of interest after the updating.

19. The computer program product of claim 15 wherein the training of the user preferences further comprises:
ingesting a set of prior user activities to the artificial intelligence system;
ingesting a set of social media posts to the artificial intelligence system; and
ingesting a set of travel history logs to the artificial intelligence system, wherein the history logs include a set of prior destinations visited by the user, and wherein the training of the artificial intelligence system with the plurality of user preferences further includes the ingested set of prior user activities, the ingested set of social media posts, and the ingested set of travel history logs.

20. The computer program product of claim 19 wherein the actions further comprise:
learning of the user preferences based on a plurality of passages included in the sets of data ingested by the artificial intelligence system.
